(19) United States
(12) Patent Application Publication
(10) Pub. No.: US 2024/0169061 A1
(43) Pub. Date: May 23, 2024

(54) TECHNIQUES FOR ACCURATE LEARNING OF BASELINES FOR THE DETECTION OF ADVANCED APPLICATION LAYER FLOOD ATTACK TOOLS

(71) Applicant: Radware Ltd., Tel Aviv (IL)

(72) Inventors: Ehud DORON, Moddi'in (IL); Alon TAMIR, Kiryat Ono (IL); David AVIV, Tel Aviv (IL)

(73) Assignee: Radware Ltd., Tel Aviv (IL)

(21) Appl. No.: 18/398,997

(22) Filed: Dec. 28, 2023

Related U.S. Application Data
(63) Continuation-in-part of application No. 18/058,482, filed on Nov. 23, 2022.

(51) Int. Cl. G06F 21/56; G06N 20/00

(52) U.S. Cl. CPC G06F 21/56; G06N 20/00; G06F 2221/034

(57) ABSTRACT

A system and method for learning attack-safe baseline are provided. The method includes receiving application-layer transactions directed to a protected entity; measuring values of a rate-based attribute and a rate-invariant attribute from the received application-layer transactions; determining, based on the measured rate-based attribute, if the received application-layer transactions represent a normal behavior; computing at least one baseline using application-layer transactions determined to represent the normal behavior; and validating the at least one computed baseline using the measured rate-invariant attribute and rate-based attribute.

### CROSS-REFERENCE TO RELATED APPLICATIONS

The present application is a continuation in part of U.S. patent application Ser. No. 18/058,482, filed on Nov. 23, 2022, now pending, the contents of which are hereby incorporated by reference.

### TECHNICAL FIELD

This present disclosure generally relates to techniques for accurate learning of baselines for the detection and mitigation of application-layer denial of service (DOS) based attacks.

### BACKGROUND

These days, online businesses and organizations are vulnerable to malicious attacks. Recently, cyber-attacks have been committed using a wide arsenal of attack techniques and tools targeting both the information maintained by online businesses, their IT infrastructure, and the actual service availability. Hackers and attackers are constantly trying to improve their attack strategies to cause irrecoverable damage, overcome currently deployed protection mechanisms, and so on.

One type of popular cyber-attack is a DOS/DDOS attack, which is an attempt to make a computer or network resource unavailable or idle. DDOS detection and mitigation systems rely heavily on anomaly detection approaches. The most basic stage of anomaly detection is learning the legitimate traffic peacetime behavior by building its normal baselines. Therefore, anomaly detection-based systems assume that the DDOS attack detection system has a sufficient period of time for the purpose of initial learning. The initial learning period usually lasts a couple of days or weeks when there is no active attack going on. For HTTP Floods attack detection, the learning period is used to understand the protected entity's legitimate behavior normally. The legitimate behavior normal baseline is achieved according to the various applicative features learned by the detection system and its various algorithms. Only after the initial learning period is concluded, the detection system has all its required normal baselines, and it becomes operational. This means that it is fully ready for accurate attack detection and mitigation.

As HTTP Flood attacks are becoming more frequent, security teams are facing significant challenges when it comes to allowing a learning period free from such attacks. This initial learning period is essential to start active and accurate detection. However, since applications are constantly attacked, the result is that the learning period is contaminated with attacker traffic, making it difficult to ensure accurate attack detection. Ironically, in such cases, legitimate traffic can also be detected as an attack. In some cases, the learning process is even initiated during an active attack. This challenge can be seen as a “chicken and egg” problem. How can a detection system ensure safe learning against attacks when it lacks the prerequisites for detecting attacks accurately? ‘Further, one challenge with the current learning approaches is the lack of means to ensure the quality of learning. It is uncertain whether the learning has concluded in a way that allows active attack detection to begin once all baselines accurately represent the legitimate normal application behavior.

It would be, therefore, advantageous to provide an efficient security solution for safeguarding the learning period needed for the purpose of accurate detection of HTTP and HTTPS flood attacks.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” or “one aspect” or “some aspects” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include receiving application-layer transactions directed to a protected entity. Method may also include measuring values of a rate-based attribute and a rate-invariant attribute from the received application-layer transactions. Method may furthermore include determining, based on the measured rate-based attribute, if the received application-layer transactions represent a normal behavior. Method may in addition include computing at least one baseline using application-layer transactions determined to represent the normal behavior. Method may moreover include validating the at least one computed baseline using the measured rate-invariant attribute and rate-based attribute. Other embodiments of this aspect include corresponding computer systems, apparatus, and computer programs recorded on one or more computer storage devices, each configured to perform the actions of the methods.

In one general aspect, system may include one or more processors configured to receive application-layer transactions directed to a protected entity. System may furthermore include measure values of a rate-based attribute and a rate-invariant attribute from the received application-layer transactions. System may in addition include determine, based on the measured rate-based attribute, if the received application-layer transactions represent a normal behavior. System may moreover include computing at least one baseline using application-layer transactions determined to represent the normal behavior. System may also include validating the at least one computed baseline using the measured rate-invariant attribute and rate-based attribute. Other embodiments of this aspect include corresponding computer systems, apparatus, and computer programs recorded on one or more computer storage devices, each configured to perform the actions of the methods.

In one general aspect, non-transitory computer-readable medium may include one or more instructions that, when executed by one or more processors of a device, cause the device to: receive application-layer transactions directed to a protected entity; measure values of a rate-based attribute and a rate-invariant attribute from the received application-layer transactions; determine, based on the measured rate-based attribute, if the received application-layer transactions represent a normal behavior; compute at least one baseline using application-layer transactions determined to represent the normal behavior; and validate the at least one computed baseline using the measured rate-invariant attribute and rate-based attribute. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram utilized to describe the various embodiments for the detection of HTTP flood attacks according to some embodiments.

FIG. 2 is a flow diagram illustrating the operation of the detection system according to some embodiments.

FIG. 3 is a structure of a window or baseline buffer according to an embodiment.

FIG. 4 demonstrates a distribution density function for a query arguments type of AppAttributes according to an embodiment.

FIGS. 5A, 5B and 5C are diagrams of window buffers utilized to demonstrate the process of updating baselines according to an embodiment.

FIG. 6 is a flowchart illustrating a method for the detection of HTTP flood attacks according to an embodiment.

FIG. 7 is a flowchart describing a method for detecting a rate-based anomaly according to an embodiment.

FIG. 8 is an example flowchart describing a method for detecting a rate-invariant anomaly according to an embodiment.

FIGS. 9A, 9B, 9C, and 9D illustrate the building and updating of baseline and window buffers according to an embodiment.

FIG. 10 is an example process used for an initial learning process to establish an initial baseline in accordance with an embodiment.

FIG. 11 is a flowchart of an example process for safeguarding a learning process to establish attack-safe baselines during the active learning period according to an embodiment.

FIG. 12 is a flowchart of an example process for determining if application-layer transactions represent a normal behavior according to the disclosed embodiments.

FIG. 13 shows an example graph demonstrating the process for safeguarding baselines learning process.

FIG. 14 shows an example diagram of a state machine illustrating the process performed during the baseline learning period according to an embodiment.

FIG. 15 is an example block diagram of the system implemented according to an embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be plural and vice versa with no loss of generality. In the drawings, like numerals refer to like parts through several views.

The various disclosed embodiments include a method for the detection of HTTP flood DDOS attacks. The disclosed method distinguishes between malicious traffic and legitimate (flash crowd) traffic to allow efficient detection of HTTP Flood attacks. The detection is based on comparing a baseline distribution of application attributes (AppAttributes) learned during peacetime to distributions of AppAttributes measured during an attack time.

According to the disclosed embodiments, the learned baselines are attack-safe baselines. That is, during a pre-defined learning period, the traffic is monitored and processed to establish the normal baselines while ensuring that the learned traffic is legitimate client traffic and is not an attacker traffic. To this, during the learning period, the disclosed embodiments and method and system are configured to receive application-layer transactions directed to a protected entity; measure values of a rate-based attribute and a rate-invariant attribute from the received application-layer transactions; determine, based on the measured rate-based attribute, if the received application-layer transactions represent a normal behavior; compute the baseline using application-layer transactions determined to represent the normal behavior; and, at the end of the learning period, validate the computed baseline using the measured rate-invariant attribute and rate-based attribute. Thus, the disclosed embodiments allow for establishing accurate attack-safe baselines and, therefore, ensure accurate detection of attacks with fewer false positive and false negative alerts.

The disclosed embodiments establish attack-safe baselines prior to initiating any attack detection. As a result, these baselines can be learned before the system's operation. Once established, these baselines are continuously updated during the detection of attacks, which is an ongoing process for the disclosed system. By means of the established baselines, the disclosed embodiments allow fast detection of HTTP flood DDOS attacks while allowing proper operation of a protected entity during a flash crowd event. It should be appreciated that the number of requests directed to a protected entity (e.g., a web application, an API application, and such) during such an attack or when a flash crowd occurs could be millions to tens of millions of requests per second. As such, a human operator cannot process such information and indicate if the received or observed traffic is legitimate or not.

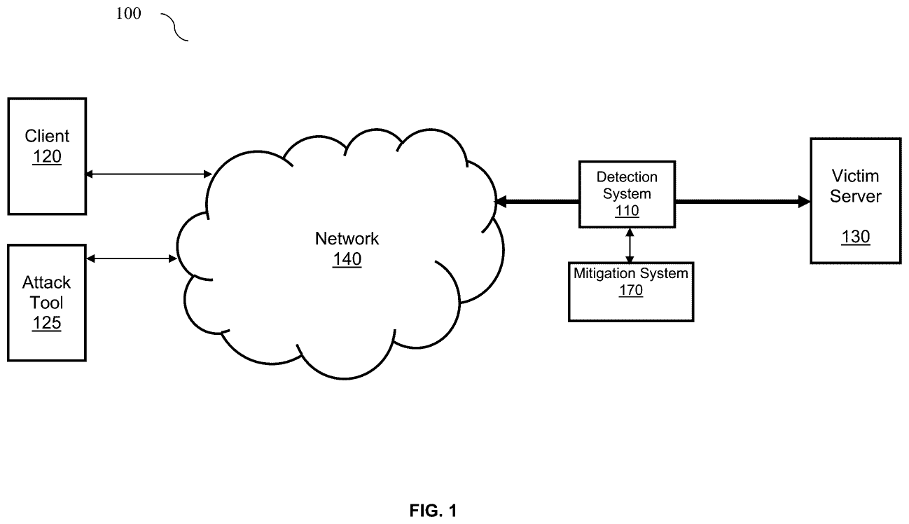

FIG. 1 is a schematic diagram 100 utilized to describe the various embodiments for the detection of HTTP flood attacks according to some embodiments. HTTP flood attacks are one type of a DDOS cyber-attack. In a schematic diagram 100, client device 120 and attack tool 125 communicate with a server 130 over a network 140. To demonstrate the disclosed embodiments, the client device 120 is a legitimate client (operated by a real legitimate user or other legitimate WEB client entities), the attack tool 125 is a client device (operated, for example, as a bot by a botnet), and the server 130 is a “victim server”, i.e., a server under attack can be any type of WEB based application, API based application, and the like.

The legitimate client 120 can be a WEB browser, other types of legitimate WEB application client, or WEB User Agent and the like executing over a computing device, such as a server, a mobile device, a tablet, an IoT device, a laptop, a PC, a TV system, a smartwatch and the like.

The attack tool 125 carries out malicious attacks against the victim server 130 and particularly carries out HTTP, and/or HTTPS flood attacks. The attack tool 125 generates and sends “legitimate looking” HTTP requests with the objective of overwhelming its victims, legitimate online server's resources like victim server 130. The attacker generated HTTP requests have the correct structure and content as required by the HTTP protocol and its common practices, and because of that, these requests look “legitimate” even though they were generated by an attacker with malicious purposes. When structuring the attack, the attacker makes use of a large amount of randomization or pseudo-randomization. In some cases, the attacker structures a large set of distinct “legitimate” requests and randomly selects the HTTP requests to be transmitted as the attacking requests during selected periods of time. It should be noted that the attacker generates a large number of distinct HTTP requests to be able to evade fingerprinting and mitigation by simple WEB filtering, or other exciting means of attack mitigation. As such, detection of such attacks by a human operator is not feasible.

The attack tool 125 may be an HTTP Flood attack tool that can be deployed as a botnet, as a HTTP Flood attack tool using WEB proxies, without using WEB proxies (e.g., direct usage of hosted servers to generate the attack) or using legitimate home routers that operate as WEB proxies. This enables the attacker to disguise its Internet identity and, by eliminating any chance to naively identify his HTTP requests only by pre-knowledge of their source IP addresses. The attack tool 125 also can be deployed as a WEB stresser, DDoSers, and other “DDOS for hire” forms of attacks.

The attack tool 125 generates requests with a legitimate structure and content. To obtain the “legitimate structure”, attacker-generated HTTP requests may include one or more legitimate URLs within the protected application (or victim server 130), a set of common HTTP headers, and contain one or more query arguments. The attack tool 125 can constantly include a specific HTTP header (standard headers or non-standard headers) or query arguments in its generated HTTP requests or randomly decide to include or exclude them in each generated request or set of requests. Attack tool 125 can also randomly, per transmitted HTTP transaction, decide the HTTP method and the URL to attack at the victim server.

The requests generated by attack tool 125 can also contain legitimate and varied content. To make its generated requests look “legitimate”, the attack tool generated HTTP requests can have HTTP headers with legitimate values (e.g., UserAgent can be randomly selected from a pre-defined list of legitimate UserAgent values, Refere can be randomly selected from a pre-defined list of legitimate and common WEB sites, e.g., facebook.com, google.com).

These overall operations of the attack tool 125 can result in a set of tens of thousands, or even millions, of distinct attacker's HTTP requests. The attacker uses randomization to select the actual HTTP request to send to its victim in each request transmission. Therefore, aiming to simply recognize the millions of distinct attacker's requests “as is” will be a very tedious, almost impossible, task. It is important to note that these tools have numerous mutations and variants, but still follow similar operations, and by that, the HTTP requests they generate are as described above. Advanced attack tools are designed to bypass simple Layer-7 filtering for mitigation by generating a large set of distinct and “legitimate-looking” HTTP requests. As such, no dominant, or frequent, set of several HTTP requests can be simply characterized as issued by the attack tool 125.

It should be noted that an attacker may craft HTTP Floods attack that uses a lower level of randomization, e.g., HTTP method is GET constantly, or without using any kind of randomization. The disclosed embodiment aims to detect HTTP Flood attacks regardless of the level of randomization realized by the attack tool used.

Requests generated by the legitimate client device(s) 120 are more diverse in their structure and content compared to the attacker's requests. The legitimate client HTTP requests potentially have more HTTP headers, standard and non-standard headers, turn to a plurality of URLs within the victim server 130, have more key-value pairs in Cookie, use more query arguments, and more. All of these attributes appear in HTTP requests and responses depending on the application activities, such as login, simple browsing to the home or landing page, turning to a specific area with the application, and such. Based on the higher diversity and unique content distribution of legitimate requests, the detection of HTTP Floods attacks and their differentiation from legitimate flash Flood may be possible.

The attack tool 125, in its basic sense, aims and is designed to arm an attacker with the ability to overwhelm as many online WEB assents as possible. As such, attack tools are neither directed nor targeted to attack a specific target. The HTTP requests crafted and then generated by an attack tool in the majority of cases are not fully targeted to the attacked application. Therefore, the attacker's requests may look legitimate, but predominantly do not necessarily include any application specific attributes. Application specific attributes, hereby referred to as AppAttributes, can be any part of the incoming HTTP requests, and their corresponding HTTP responses, which are unique to the specific protected application, or victim server 130, and by that can identify the legitimate “applicative behavior” of the protected application, or victim server 130.

The AppAttributes can be comprehended as: “something that can be simply introduced by legit clients 120 and not by attack tools like 125”. This capability is utilized by this invention for the purpose of distinguishing legit traffic surges, or flash crowd, or flash Flood, from those Flood caused by an attacker. Attack tools have insignificant knowledge of the application legitimate behavior, and by that the attack traffic applicative behavior has low “proximity” to normal legitimate behavior. Flash crowds are legitimate, therefore have a legitimate nature, and by that flash crowd traffic applicative behavior has some level of “proximity” to the normal.

It should be noted that the embodiments disclosed herein are applied when multiple attack tools execute the attacks against the victim server 130 concurrently. Similarly, a vast number of legitimate client devices 120 can operate concurrently to be delivered with the services proposed by the server 130. Both client device, or devices, 120 and attack tool, or attack tools, 125 can reach the victim server 130 concurrently. The network 140 may be, but is not limited to, a local area network (LAN), a wide area network (WAN), the Internet, a content delivery network (CDN), a cloud network, a cellular network, and a metropolitan area network (MAN), a wireless network, an IoT network, or any combination thereof. Similarly, the victim server 130 can be built from one or a plurality of servers.

According to the disclosed embodiments, a detection system 110 is deployed between client device 120, attack tool 125, and victim server 130. The deployment can be an always-on deployment, or any other deployment that enables the detection system 110 to observe incoming HTTP requests and their corresponding responses during peace time and during active attacks time. The detection system 110 may be connected to a mitigation system 170 configured to characterize and mitigate attack traffic. An example embodiment for the mitigation system 170 is discussed in U.S. patent application Ser. No. 17/456,332 assigned to the common assignee.

The detection system 110 and the victim server 130 may be deployed in a cloud computing platform and/or on-premises deployment, such that they collocate together, or in a combination. The cloud computing platform may be, but is not limited to, a public cloud, a private cloud, or a hybrid cloud. Example cloud computing platforms include Amazon® Web Services (AWS), Cisco® Metacloud®, Microsoft® Azure®, Google® Cloud Platform, and the like. In an embodiment, when installed in the cloud, the detection system 110 may operate as a SaaS or as a managed security service provisioned as a cloud service. In an embodiment, when installed on-premises, the detection system 110 may operate as a managed security service.

In an embodiment, the detection system 110 and/or the mitigation system 170 are integrated together in a WAF (Web Application Firewall) device or a dedicated Layer 7 DDOS detection and mitigation device. In yet another embodiment, the detection system 110 and/or the mitigation system 170, are integrated together in any form of WEB proxy (reverse proxy and forward proxy and alike) or a WEB server. In yet another embodiment, the detection system 110 and/or the mitigation system 170 can be integrated in WEB caching systems like CDN and others.

The victim server 130 is the entity to be protected (protected entity) from malicious threats. The server 130 may be a physical or virtual entity (e.g., a virtual machine, a software container, a serverless function, an API gateway, and the like). The victim server 130 may be a WEB server (e.g., an origin server, a server under attack, an on-line WEB server under attack, a WEB application under attack, an API server, a mobile application, and so on). The protected entity may include an application, a service, a process, and the like executed in the server 130.

According to the disclosed embodiments, during peace time and during the initiation of an active attack, the detection system 110 is configured to detect changes, or fast increasements, in the transmission rate, or requests per second (RPS), of traffic directed to the server 130. Upon such detection, an indication that a potential DDOS attack is on-going may be provided. The indication of a potential attack, as the packet and/or HTTP requests transmission rate increases, may also result from flash crowd traffic. The detection indication may be referred to as a rate-based anomaly that may indicate transition from peacetime conditions. The transition may be from a peacetime condition (normal traffic, when no active attackers send traffic to the victim) to a potential attack, or to flash crowd conditions.

In an embodiment, a rate-based anomaly is determined by rate-based traffic parameters. An example of such a parameter includes, but is not limited to, Layer-7 RPS or the number of HTTP requests per second. In yet another embodiment, such parameters can include layer-3 attributes, such as like bit-per-second and packets-per-second, layer-4 attributes like, TCP SYN per second, number of TCP connections per second (new and existing connections), and such. A rate-based anomaly is characterized by a steep increase in the traffic rate attributes in a short period of time. To this end, a rate-based anomaly threshold is defined, as the level of RPS (or other Layer 3 or Layer 4 attributes) to be considered as legitimate or normal level of RPS such that the crossing of such threshold is indicative of a transition from a peacetime to a potential attack, or RPS anomaly. When the RPS fails to meet the anomaly threshold, it can be an indication of rate-based anomaly.

In an example embodiment, the rate-based anomaly threshold is calculated for each time window and a protected entity, using a combination of alpha filters which are configured over a short (e.g., 1 hour) and medium (e.g., 8 hours) duration. Other durations for the alpha filters are also applicable. An RPS baseline and anomaly threshold are discussed below. It should be emphasized that the comparison to the RPS anomaly threshold is performed for each time window. For example, such a time window is set to 10 seconds. The time window allows for a stable detection of an attack to occur and operate during a short period of time.

According to the disclosed embodiments, to distinguish between legitimate flash Flood and attack traffic floods, the detection system 110 is configured to examine the applicative transactions. The transactions are requests, such as HTTP requests, sent to the victim server 130, and the requests' corresponding responses, such as HTTP responses, sent by the victim server 130 as a reaction to HTTP requests it receives. The detection system 110 is configured to analyze the received transactions and determine if rate-invariant parameters in the transactions demonstrate normal or abnormal behavior of the application. An abnormal behavior indicates an HTTP flood DDOS attack, or a rate-invariant anomaly. On the contrary, normal behavior is indicative of legitimate flash crowd situations.

In an embodiment, the rate-invariant parameters are AppAttributes that have their baselines developed during peacetime and are monitored during a potential attack time. In yet another embodiment, the AppAttributes uniquely attribute legitimate behavior of HTTP requests sent to the protected entity, and corresponding HTTP responses sent by the protected entity. In yet another embodiment, the AppAttributes may be of different types. The AppAttributes types can be pre-selected, and the same set of types can be used when developing the baseline and while detecting a potential anomalous behavior.

As discussed in detail below, the detection system 110 is configured to alert of a potential HTTP flood DDOS attack based in part on a comparison between AppAttributes buffers (hereinafter “window buffers”) generated for a current time window, and baseline AppAttributes buffers (hereinafter “baseline buffers”) calculated over past time window. As requests generated by an attack tool do not demonstrate an AppAttributes distribution approximate to the baseline, unlike a legitimate client's AppAttributes distribution, it is expected that during attack time windows a different AppAttributes distributions are demonstrated. Using this fact, the operation of the detection system 110 would enable it to effectively distinguish flash crowd conditions from attack scenarios. Note that the baseline AppAttributes represents the victim application's legitimate, or normal, behavior. The victim application 130 unique baseline AppAttributes distributions, as learned at peacetime, describes the unique behavior of the protected application as appeared in its requests and responses.

In the example deployment, shown in FIG. 1, the detection system 110 may be connected in-line with the traffic between the client device 120 and the attack tool 125 toward the victim server 130. In this deployment, the detection system 110 is configured to process ingress traffic from the client device 120 and the attack tool 125, as well as egress traffic, or the return path, from victim server 130 back to device 120 and, in cases of attack, the attack tool 125.

In yet another configuration, the detection system 110 may be an always-on deployment. In such a deployment, the detection system 110 and the mitigation system 170 are part of a cloud protection platform (not shown). In yet another embodiment, a hybrid deployment can be suggested, where the detection system 110 is deployed on the cloud, and the mitigation system 170 is deployed on-premises close to the victim server 130.

It should be noted that although one client device 120, one attack tool 125, and one victim server 130 are depicted in FIG. 1, merely for the sake of simplicity, the embodiments disclosed herein can be applied to a plurality of clients and servers. The clients may be located in different geographical locations. The servers may be part of one or more data centers, server frames, private cloud, public cloud, hybrid cloud, or combinations thereof. In some configurations, the victim server 130 may be deployed in a data center, a cloud computing platform, or on-premises of an organization, and the like. The cloud computing platform may be a private cloud, a public cloud, a hybrid cloud, or any combination thereof. In addition, the deployment shown in FIG. 1 may include a content delivery network (CDN) connected between client 120 and attack tool 125 and to server 130. In an embodiment, the detection system 110, and the mitigation system 170, are deployed as part of the CDN.

The detection system 110 may be realized in software, hardware, or any combination thereof. The detection system 110 may be a physical entity (an example block diagram is discussed below) or a virtual entity (e.g., virtual machine, software container, micro entity, function, and the like).

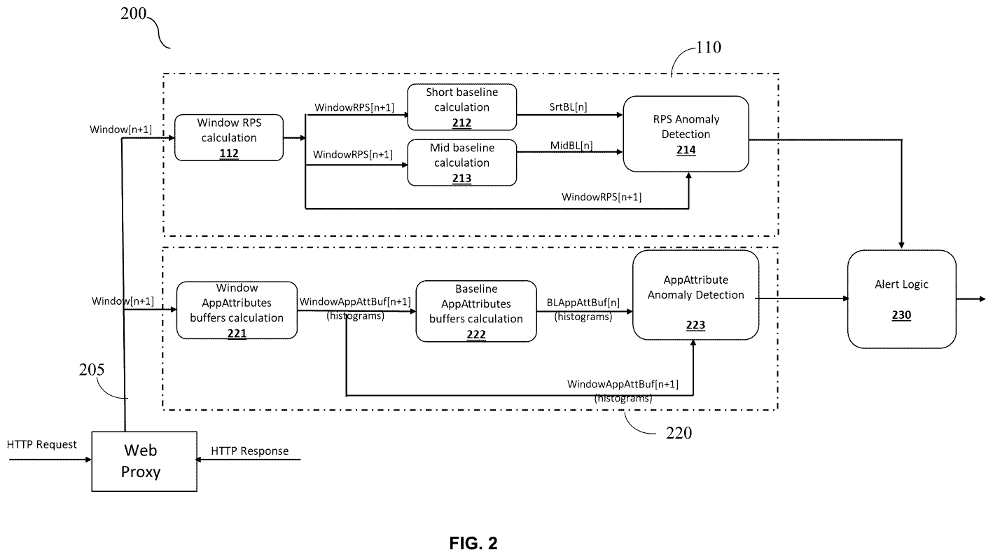

FIG. 2 shows an example flow diagram 200 illustrating the operation of the detection system according to some embodiments. The detection of HTTP flood attacks is performed during predefined time windows, where an indication can be provided at every window. The baseline is developed over time based on transactions received during peacetime. There are two paths of detection: rate-based (labeled 210) anomalies detection and rate-invariant (labeled 220) anomalies detection. In an embodiment, rate-based features are traffic-related features that tend to be increased during time periods when the traffic increases. In another embodiment, rate-invariant features are traffic-related features that do not tend to be increased during time periods when the traffic is increasing.

The rate-based path 210 will be discussed with reference to a specific rate parameter, the total number of requests per second (RPS) as arrived towards the victim server.

Transactions 205 as received by the detection system 110 are fed to both paths for processing. This may include receiving the traffic by a WEB proxy, to decrypt the traffic, when HTTPS is used, render the incoming requests and their corresponding responses. In an embodiment, described in FIG. 2, the WEB proxy is part of the detection system 110. In yet another embodiment, the WEB proxy can be external (e.g., a CDN, a WEB server, etc.) to the detection system 110. In the latter case, the detection system 110 is configured with a pre-defined interface to the WEB proxy to further receive the WEB transactions arriving to, or from, the victim server 130. The processing is performed per time window, but continuously through the operation of system 110. The duration time window is a few seconds, e.g., 10 seconds long.

In the rate-based path, a check is attempted for a potential attack to be initiated due to an increase in the number of transactions and their rate. Specifically, at block 210, the RPS of the current window (n+1, wherein ‘n’ is an integer) is computed. The value of the RPS[n+1] is computed as follows:

WinRPS[n+1]=total requests/time window duration Eq. 1

Where, the total number of requests is the number of requests received during a time window [n+1]. Then, short, and medium baselines are computed at blocks 212 and 213, respectively. The baselines SrtBL[n] and MidBL[n] are the mean and variance values of the RPS when applying different alpha filters on such values. In an embodiment, the mean and variance (var) values may be computed using an alpha filter as follows:

RPS_mean_{[n+1]}=RPS_mean_{[n]}·(1−α)+RPS_{[n+1]}·α Eq. 2

RPS_var_{[n+1]}=RPS_var_{[n]}·(1−α)+RPS_{[n+1]}_{^{2·α+RPS_mean}}_{[n]}_{²}·(1−α)−RPS_mean_{[n+1]}_{²} Eq. 3

Where the ‘α’ value for the ‘short’ baseline (SrtBL[n]) is smaller than the α value for the ‘mid’ baseline (MidBL[n]). The SrtBL[n] and MidBL[n] baselines are defined using the RPS_mean_{[n+1]} and RPS_var_{[n+1]}. The RPS_var is the variance of the measured RPS, correspondingly.

In an embodiment, the short baseline is utilized to follow hourly increasements in RPS, especially for 24 by 7 legitimate WEB traffic patterns, and by that, uses an alpha fitting for averaging over the last hour. The medium (‘mid’) baseline is utilized to follow burst RPS traffic patterns. In an embodiment, the duration of the alpha filter can be configured to dynamically fit other types of patterns and attack detection sensitivities. In yet another embodiment, the detection system 110 supports multiple alpha filters to cover other types of patterns and multiple integrations, or averaging, periods.

At the RPS anomaly detection block 214, each of the SrtBL[n] and MidBL[n] baselines are used to build an RPS anomaly threshold (TH). In peacetime at the end of each time window, e.g., each 10 seconds, the RPS anomaly threshold (TH) calculated for the previous time windows, is compared against the current WindowRPS to find an RPS anomaly. In an embodiment, the threshold for an RPS anomaly, for window n+1, may be defined as follows:

RPS anomaly TH[n+1]=max{(RPS anomaly TH)_{α-short},(RPS anomaly TH)_{α-mid}} Eq. 4
where:

(RPS anomaly threshold)_{α}=max{(averageFactor)*RPS_mean,RPS_mean+STD_Factor*SQRT(RPS_var)} Eq. 5

where RPSₘₑₐₙ is the mean of the RPS as computed in Eq. 2, RPSᵥₐᵣ is the variance of the RPS as computed in Eq. 3, the alpha (short and mid), MAF or the Minimum Attack Factor, STD_Factor values are predefined. The Minimum Attack Factor is defined as the minimum multiplication of the attacker RPS over the legitimate level of RPS, to be considered an HTTP Floods attack. For example, for MAF=3, only WindowRPS volumes of above 3 times RPS_mean can be considered as RPS anomaly. Another possible case for RPS anomaly is when the WindowRPS is higher than the baseline together with STD_Factor times the calculated standard deviation (the square root of the RPS_var). It should be noted that RPS is only one example of a rate-based parameter, and other parameters, like layer 3 and layer 4 attributes, can be used herein.

The values of ‘α’ are preconfigured, where the higher the ‘α’ value is, the weight given to the current window RPS, or to the WinRPS[n+1], value is higher, comparing the previously received RPS. The lower the ‘α’ value is, the weight given to past RPS values is higher, comparing the RPS received in current window, which means a slow reaction to relatively fast (hourly) changes in RPS. In an example, a short ‘α’ value is set to 0.005 and a mid ‘α’ value is to 0.0008 for the mid filter.

When the value of the current window RPS WinRPS[n+1] exceeds the RPS anomaly threshold [n+1], an RPS rate-based anomaly is decided.

In the rate-invariant path 220, it is checked if there is a deviation from the AppAttributes baseline behavior for the current time window. According to the disclosed embodiments, each protected application is assigned with a set of two buffers: baseline and window. Each set of the baseline and window buffers contains buffers for each AppAttributes type. Examples of AppAttributes types are provided herein.

Application Attributes, or AppAttributes, are attributes in HTTP requests and response header, mainly keys, that uniquely attribute the victim server application legitimate behavior as can be inferred by analyzing the application legitimate HTTP requests and their corresponding HTTP responses. In an embodiment, the AppAttributes can be described as a “feature vector” that includes the several AppAttributes types.

In yet another embodiment, AppAttributes type can be the keys of non-standard HTTP headers (or unknown HTTP headers) in HTTP requests, the key of each cookies in the cookie header in HTTP requests, the key of each query argument in requests URL, the HTTP request sizes, the HTTP response sizes, the HTTP response status code, source client IP address attributes, as appeared in X-Forwarded—For header or in Layer 3 IP header, like geo-location (e.g. country and city) and ASN assignments and the like, User Agent values, the TLS figure printing values computed over client-hello messages in the incoming traffic, the distribution of the time duration in seconds between HTTP request and their corresponding HTTP response, the key of each cookies in cookie of HTTP response set-cookie header. When selecting AppAttributes types it is essential to select applicative attributes that their values and distributions uniquely identify legitimate traffic, as presented in legitimate traffic, but cannot be introduced by an attack tool. This is because transactions generated by the attack tool are generic as the attack tool is not targeted to the specific victim server application. As such, it is to assume that requests crafted by an attack tool will not have an AppAttributes distribution similar to the distribution legit client's requests have. In an embodiment, the AppAttribute provides a measure to distinguish flash crowd conditions from attack scenarios.

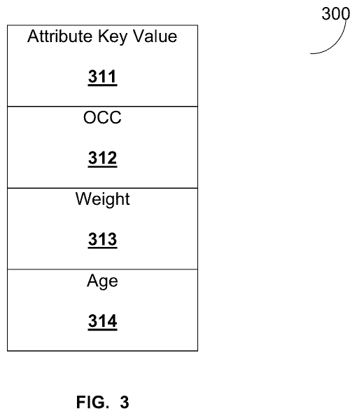

An example of AppAttributes buffer 300, which is a window buffer or a baseline buffer, is shown in FIG. 3. The buffer 300 includes an AppAttribute key value field (311), an occurrence (occ) field (312), a weight field (313), and an age field (314).

The AppAttribute key value field (311) includes a name of the key value, such as query arguments (args) name, a non-standard HTTP header name, a cookies name, an HTTP request size range, an HTTP response size range, an HTTP response status code (e.g., 200), source IP address attribute (geo, ANS and alike), User Agent values, TLS figure print attribute, a set-cookie cookies name and the like. The Occ field (312) represents the number of occurrences, or the average number of occurrences, for an AppAttributes specific key value over a period of time. The weight field (313) includes the AppAttributes specific key value occurrences relating to other AppAttributes (from the same type) appeared in the same received HTTP requests. As an example, the weight value may be set to:

Weight=1/(total number AppAttributes appeared in a transaction) Eq. 6

The age field (314) represents the last time an AppAttribute key value was observed in a received HTTP request.

For each AppAttributes type multiple buffers are created, one for each AppAttribute key value. The buffers are saved in a memory of the system 110, and the number of buffers, in an embodiment, is limited to allow safe memory management and eliminate an attacker to overwhelm detection system 110 memory during an active attack, where a vast number of new AppAttribute keys value might be appeared. Attack tool is, in many cases, not aware of the whole list of legitimate AppAttributes of each type, therefore in many cases attack tool 125 uses randomized AppAttributes keys value. During an active volumetric attack, a very large number, ten thousand or even millions, of new AppAttributes keys are expected to appear. The baseline buffers are built as a set of AppAttributes buffer 300 as shown in FIG. 3. The baseline represents histogram (statistical distribution) of the AppAttributes keys values occurrences and/or weights from a first throughout the last time window. In an embodiment, a set of buffers from the baseline buffers are pre-set with key values. In an embodiment, such AppAttributes key values may be learned during a learning phase of the system 110 and thereafter through continuous learning during peace time. The baselining includes adding new key values buffers to the existing buffers that were observed during peacetime. The baseline buffers are updated each 10 seconds window (only when no active attack is detected), based on data aggregated on the window buffers.

It should be noted that the baseline represents the behavior of AppAttributes as it appeared at the protected application during peace time. In an embodiment, the peace time baseline is compared to the AppAttributes appearance behavior during anomaly window, and by that enables the detection of rate invariant applicative anomalous behavior.

The window buffers are also built as a set of AppAttributes buffer 300 as shown in FIG. 3 and it represents the histogram over the AppAttributes occurrences for the last time window only. That is, the window buffers are matched in their structure to the baseline buffers. For each AppAttributes type, the window buffers are divided into two sections. One section contains AppAttributes keys pre-assigned to AppAttributes from the baseline buffers. The second section is pre-allocated with AppAttributes buffer to be assigned for new AppAttributes keys values. The structure of a buffer as disclosed here ensures accounting for previously observed AppAttributes and eliminate new arriving AppAttributes from overwhelming the window buffers. The update of window AppAttributes buffer includes parsing an incoming transaction (request and response) to identify an AppAttribute and add or update a key value in the respective buffer; incrementing the occ field (312), if applicable, updating the weight field (313) based on Eq. 6 above; and setting the age field (314) to a timestamp of a current window time. The update of window buffers is performed for each time window. In an embodiment, the respective buffers are updated by each incoming HTTP transaction. In yet another embodiment, the respective buffers are updated by sampled incoming HTTP transactions. The sampling can be for 1 in N transactions, the first N transactions in a time window, and similar. In yet another embodiment, the sampling rate N can be different for peacetime conditions and attack time conditions, to better adjust to the number of HTTP requests transmitted toward the protected entity.

In an embodiment, the baseline buffers are updated as long as there is no RPS anomaly, and no active HTTP Floods attack is detected. Further, an aging mechanism is applied on the baseline buffers, where values in the buffer that are older (according to their age value) than an aging threshold, are removed.

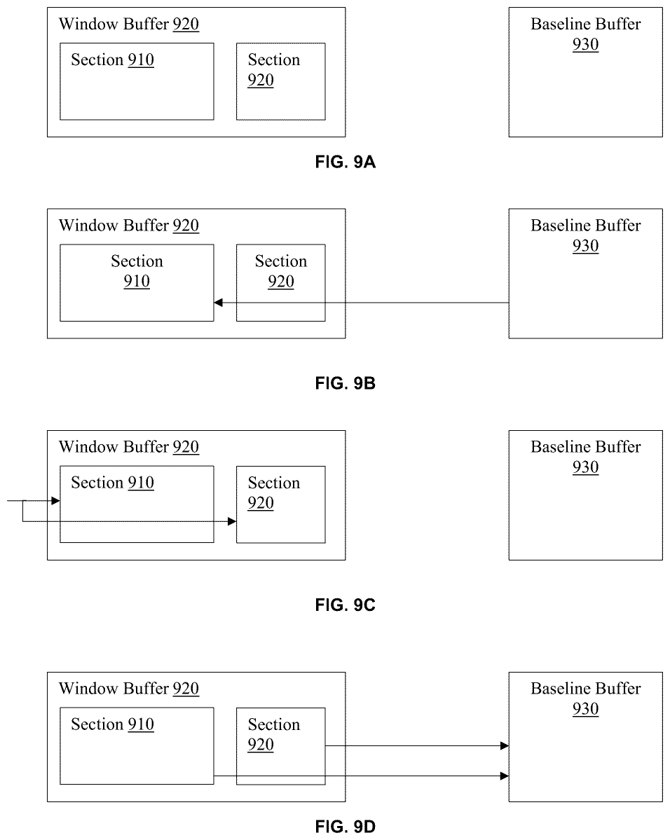

FIG. 9A illustrates the structure of the baseline buffers and the window buffers and the processes to build and update such buffers. A set of buffers for a single AppAttributes type, e.g., query arguments keys, cookies keys and so on, is shown in FIG. 9A for ease of the description.

A window buffers 900 includes 2 sections: a baseline values section 910 and a first values section 920. Each of these sections is built from a set of buffers; each buffer is built from a set of fields as depicted in FIG. 3. The values in the section 910 are copied from the baseline buffers 930 at the beginning of each window. In the section 920, new values observed during a time window for the first time, i.e., values that do not appear in the baseline section, are recorded. The size of the section 920 is limited not to saturate the system's resources during an active attack. That is, the section 920 is configured to record or buffer up to a certain pre-defined number of new values.

The baseline buffers 930 includes the baseline of AppAttributes for a specific AppAttributes type. The baseline buffers 930 are built from a set of buffers, each buffer is built from a set of fields as depicted in FIG. 3. The values in the baseline buffers 930 are updated at the end of each time window to include the values buffered in both sections 910 and 920 of window buffers throughout the last time window. It should be noted that the baseline buffers 930 is updated only if no attack is detected during the time window. The baseline buffers 930 are aggregated with AppAttributes values learned during a learning phase. However, once the system 110 is deployed and in operation, the system baseline buffer 930 is continuously updated at the end of each time window with values observed during peacetime. In an embodiment, the time window is set to 10 seconds.

FIG. 9B demonstrates the update of window buffers 900 at the end of each time window, with AppAttributes values learned and aggregated in the baseline window. FIG. 9C demonstrates the update of window buffer 900 during each time window according to values appeared in the incoming HTTP requests and response. Here it is assumed that new AppAttributes values are observed during a time window. FIG. 9D demonstrates the update of baseline buffer 930 at the end of each time window where normal activity is observed with AppAttributes appearing in web transactions received during the time window just ended. For AppAttributes existing in the baseline need to update their occ and weight fields. For new AppAttributes, new buffers should be allocated in the baseline buffers with the window occ and weight fields.

Referring to FIG. 2, at block 221, window buffers (WinAppAttBuf[n+1]) are computed at the end of the window based on transactions received at a time window (n+1). The WinAppAttBuf[n+1] buffers are histograms fed to block 222 to update the baseline buffers with current window (n+1) AppAttribute values and to block 223 to determine if there is a rate invariant anomaly based on the AppAttributes. The actual update of the baseline buffers is performed only when no active attack is detected as it is undesirable to allow attackers any means to influence the AppAttributes normal baseline values.

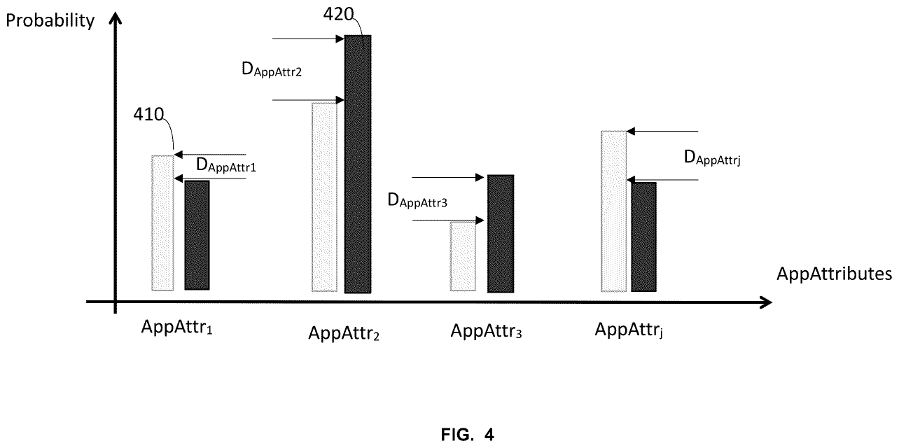

Specifically, the determination of AppAttributes anomalies is based on an attack proximity indicating how statistically close the WinAppAttBuf[n+1] window buffers are to the BLAttBuf[n] baseline buffers. Each AppAttributes buffer can be presented as a single bar, and the entire buffers from a specific type can be presented as a histogram where the AppAttribute key value is the X axis of the histogram and the occurrences, or the weight represents the Y axis of the histogram. From these histograms, form both window and baseline buffers, the AppAttributes probability density function, or the distribution, can be computed to represent the probability of the appearance of each AppAttribute. For example, a distribution density function for a query arguments type of AppAttributes is shown in FIG. 4. The X Axis shows AppAttributes keys values, and the Y axis shows probabilities to encounter each the AppAttribute in a request. The bars 410 are baseline buffers and the bars 420 are window buffers.

In an embodiment, the probabilities (Pr) are determined based on the weight values in the buffers. In an embodiment, a probability of each AppAttribute (e.g., AppAttᵢ) positioned at buffer i in buffers) may be computed as follows:

$$Pr {AppAtt}_{i} = \frac{{weight}_{i}}{{\sum }_{j} {weight}_{j}} \qquad Eq . 7$$

In an embodiment, the attack proximity represents the statistical distance between the AppAttributes window distribution, and the AppAttributes baseline distribution, for each AppAttributes type.

In an embodiment, the statistical distance between the AppAttributes window distribution, and the AppAttributes baseline distribution, for each AppAttributes type, can be computed using methods, such as Total Variation distance, Bhattacharya coefficient, Kolmogorov metric, Kantorovich metric, other methods for computing probability metric means.

In an embodiment, the attack proximity is calculated using the Total Variation approach. The Attack proximity is calculated as the sum of all total variation metrics computed for each of the various AppAttributes types. An AppAttributes type total variation metric is a sum of metric distances between the window and baseline probabilities of the specific type. Such metric distances are labeled in FIG. 4 is a D_{KeyVal #i} (i=1 . . . , r, and r is the number of key values, or buffers in the buffers). The AppAttributes total variation metric can be computed as follows:

AppAttribyte Total Variation Metric=Σ_{AppAtt #i}D_{AppAtt #i} Eq. 8

where:
the metric distance D_{AppAtt #i} can be computed as follows:

D_{AppAtt #i}=|Baseline P_{AppAtt #i}−Window P_{AppAtt #i}|

where, Baseline P_{AppAtt #i} and Window P_{AppAtt #i} are the baseline and window probabilities of AppAttributes i, respectively. In an embodiment, the AppAttributes Total Variation Metric can get values from 0 (the two distributions are identical) to 2 (the two distributions are different from each other). In an embodiment, the AppAttributes metric for each type is calculated using Total Variation. In yet another embodiment, the AppAttributes metric is calculated using other Probability Metric like Bhattacharya coefficient and others.

Continuously, the attack proximity is calculated as a summary of all AppAttribute total variation Metric over all AppAttributes types:

$$Attack Proximity = {\sum }_{AppAttribute type i} AppAttributeTotalVariationMetric i \qquad Eq . 9$$

In yet another embodiment, the attack proximity is calculated as a weighted summation over the various AppAttributes types, where each type can get a different weight to express its importance over other AppAttributes types. The higher the weight is, the higher importance the specific AppAttributes type gets.

For AppAttributes type represents sizes, like HTTP requests and responses sizes, the histogram is set with static ranges. For example, for HTTP requests and response sizes for size the range in bytes would be, for example, fixed ranges like 1-100; 101-1000; 1001-10000, over 10000. For HTTP response size the size of “0” represents WEB transaction without a response, or HTTP request without any corresponding HTTP response. In yet another embodiment, dynamic and adaptive histogram ranges can be suggested to accurately represent peacetime size distribution.

When specific incoming WEB transaction does not include any value for the specific AppAttributes type, the AppAttributes is to be considered as with “None” value. For an example, when the HTTP request does not contain cookie, the cookie AppAttributes key value is considered to be “None”, and its Occ and Weight fields are to be updated and incremented by 1 accordingly.

Returning to FIG. 2, at block 223 the computed attack proximity is compared to a proximity threshold. When the attack proximity exceeds proximity threshold, an AppAttributes anomaly, or rate invariant anomaly, for the current window (n+1) is set. A HTTP Flood DDOS attack is declared when both an AppAttributes anomaly and RPS anomaly are set. When only the RPS anomaly is set, the increase in traffic may be due to a flash crowd.

In an embodiment, the proximity threshold is preconfigured. In another embodiment, a proximity threshold may be computed as follows:

ProximityThreshold=NumOfValidAppAtt*TotalVariationFactor

That is, the proximity threshold is a multiplication of number of valid AppAttributes with a preconfigured parameter (TotalVariationFactor). Factoring valid AppAttributes is required to reduce a false positive rate, where flash crowd scenarios are considered as attacks. An AppAttribute is considered valid if both the window and baseline “None” value distributions are below a pre-defined threshold.

In an embodiment, AppAttributes type is considered as “valid” for attack detection if the “None” probability for window or baseline distribution is less than a pre-defined “None threshold” (e.g., 0.5). If both window and baseline “None” probability is higher than the “None threshold,” the AppAttribute is considered as not valid to be part of attack proximity calculation and by that the proximity threshold should be tuned to fit a different number of valid AppAttributes types.

In an embodiment, the proximity threshold is dynamically learned during peace time using anomaly detection approaches. Another embodiment uses an Alpha filter, or exponential averaging, to calculate the attack proximity mean and variance. The Attack Proximity threshold is then calculated as the calculated mean with added pre-defined multiplication of the calculated attack proximity standard deviation.

At block 230 an alert logic determines if a Flood DDOS attack is detected. Specifically, the rate-invariant and rate-based indications are processed to determine what type of an alert to output. Specifically, when the rate-invariant and rate-based anomaly indications are set, an alert on a HTTP Floods attack is generated and output. When the rate-based anomaly indication is set and rate-invariant normal indication is output, an alert of flash crowd traffic is output. In all other combinations, no other alerts are set.

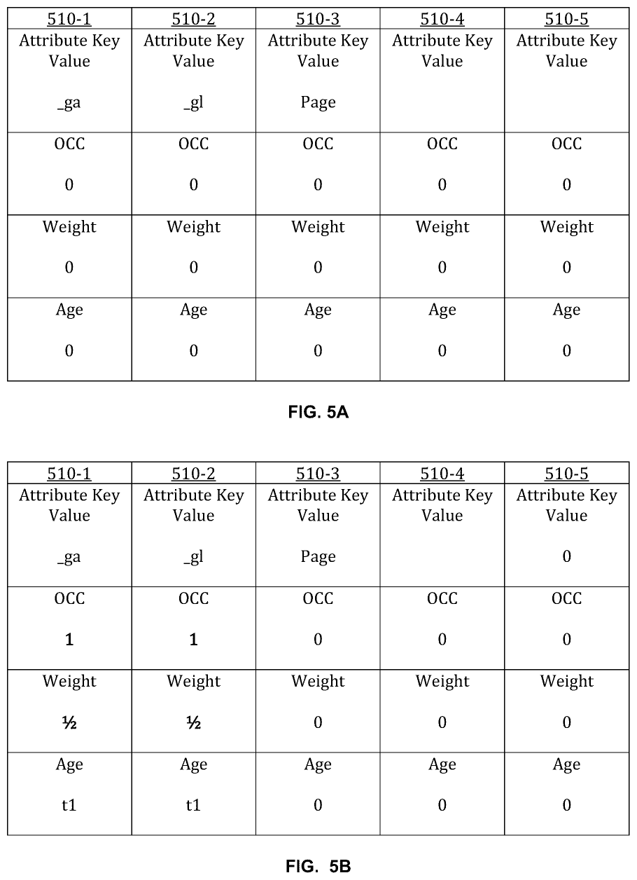

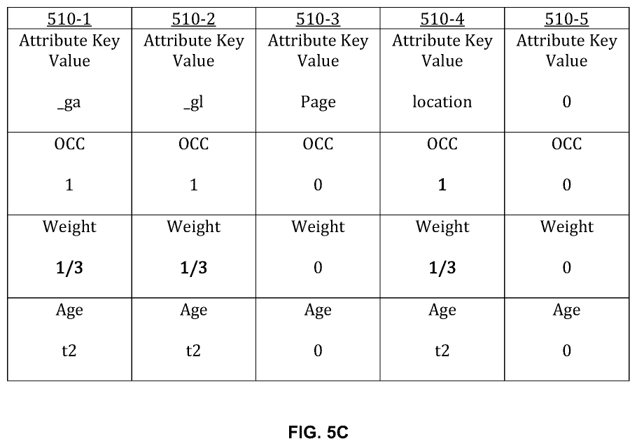

FIGS. 5A, 5B, and 5C are example window buffers utilized to demonstrate the process of updating the baseline. The baseline buffers are updated during peacetime when no anomalies are reported. The buffers utilized in the process are window and baseline. The window attribute buffers hold an aggregation of the current values observed during each time window. The baseline buffers hold the normal baseline. Both the baseline and window buffers are structured as a group of buffers as the one described in FIG. 3, but the number of buffers in each of the buffers may be different but per-defined. In an embodiment, the number of buffers, in window buffers, which can be created in response to new AppAttributes is pre-determined. This is performed to prevent creation of a large number of buffers during attacks, thereby saturating the resources of the system. In this example, the AppAttributes type is of URL query arguments.

As shown in FIG. 5A, the buffers 510-1 through 510-3 are buffers set for AppAttributes included in the baseline. At time ‘0’, at the beginning of time window, the buffers 510-1, 510-2, and 510-3 are set to include the ‘_ga’, ‘_gl’, and ‘page’ key values. These key values are existing AppAttributes that are copied from the respective baseline buffers, with occ and weight set to zero. The buffers 510-4 and 510-5 are left empty and kept for new AppAttributes that may appear in the time window. It should be noted that the window buffers are continuously updated.

For the baseline buffers, at the end of each time window (with no other anomalies found) for an already existing AppAttributes, the ‘occ’ field of its corresponding buffer is incremented with ‘ooc’ from the window buffer, and the weight and age fields are also updated. The number of buffers that can be allocated to new observed AppAttributes are predetermined. Then, the respective ‘occ,’ ‘weight,’ and ‘age’ fields are updated accordingly.

Following the above example, at a time window t=1, an HTTP request includes the following URL query arguments:
//www.domain.com/url?_ga=2.89&_gl=1093

The ‘_ga’ and ‘_gl’ are included in the URL arguments and would be included in the window AppAttributes. At the conclusion of t=1, if no attack is detected, values baseline buffers are updated to include the values of the respective buffers shown in FIG. 5B.

At the next time window t=2, an HTTP request includes the following URL query arguments:
//www.domain.com/url?_ga=2.89&_gl=1093&location=zambia

Here, the query argument named ‘location’ appears in the request. Thus, a new AppAttribute is identified and should be added to the new AppAttributes buffer allocated within the window buffer. As there are 2 free buffers (510-4 and 510-5), a buffer 510-4 is updated to include the AppAttributes ‘location’. Then, the fields of buffers 510-1 through 510-4 are updated as shown in FIG. 5C. At the end of time window t=2, assuming no active attack is detected, the baseline window buffers are updated with all value aggregated in the window buffers and here with new AppAttributes for query args. A new buffer is allocated in baseline AppAttributes only if there are free buffers to allocate in the baseline buffers. The baseline buffers are also updated to remove aged out AppAttributes.

In an embodiment, for each AppAttributes type the ‘ooc’ and ‘weight’ of all incoming HTTP requests and their corresponding responses are accumulated in the window buffers by a simple addition. At the end of the time window, the aggregated AppAttributes ‘ooc’ and ‘weight” from the window buffers is aggregated in the corresponding baseline buffers by a simple addition. In another embodiment, the window buffers ‘ooc’ and ‘weight” are aggregated into the baseline buffers using exponential average, of Alpha filter, as described in the following equation:

weight_mean_{[n+1]}=weight_mean_{[n]}·(1−α)+weight_{[n+1]}·α Eq. 10

The alpha can be set average over the last hour, e.g., the ‘α’ value is set to 0.005.

According to the disclosed embodiment, an end of attack is detected, when a few consecutive windows the following conditions should be satisfied:
1. The RPS (request per second) returns to a normal RPS baseline value;
2. The RPS is below an RPS anomaly threshold (RPS TH); or
3. The AttackProximity is below a ProximityThreshold

In order to avoid oscillations between an active attack and end-of-attack detection, some margins can be applied. For example, when attack start if RPS>baseline RPS, but same attack will end only if RPS<0.5*baseline RPS.

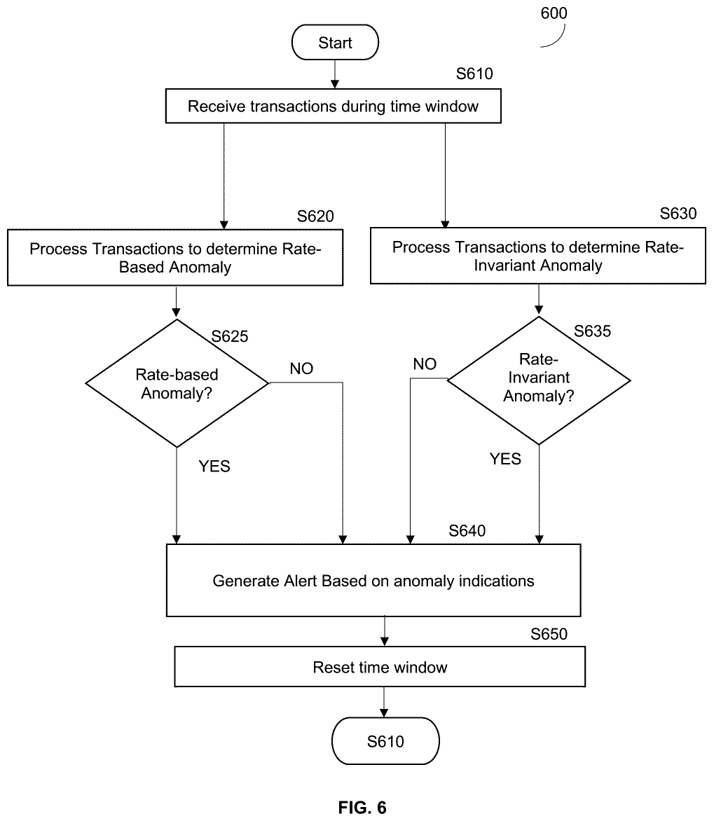

FIG. 6 shows an example flowchart 600 illustrating a method for the detection of HTTP flood attacks according to an embodiment. In an embodiment, the method may be performed using the detection system 110. The method illustrated by flowchart 600 is performed during peace time, where there is no active attack detected.

At S610, transactions are received during a time window. The duration of the time window is predetermined, and such window starts and finishes during the execution of S610. The received transactions are web transactions, and typically include HTTP requests to and their corresponding responses to/from a protected entity hosted by a victim server.

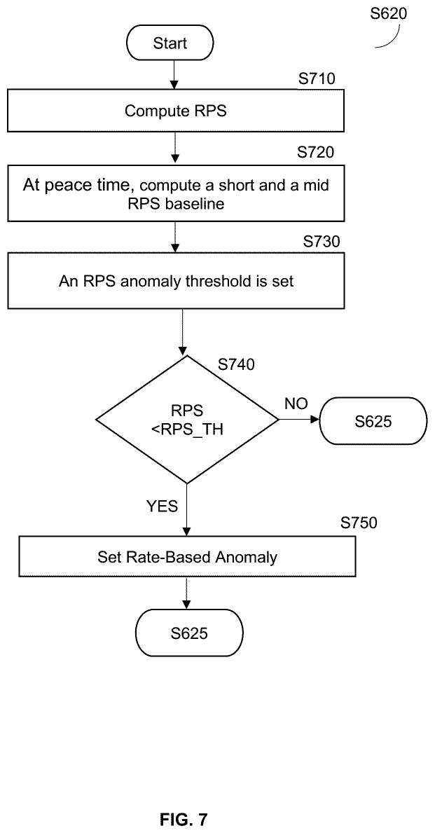

At S620, the received transactions are processed to determine if there is a rate-based anomaly in traffic directed to the victim server. In an embodiment, the rate-based anomaly is determined for at least one rate-based parameter including, but not limited to, an RPS over the total transactions received during the time window. The execution of S620 is further discussed with reference to FIG. 7.

At S625, it is checked if a rate-based anomaly is determined, and if so, a rate-based anomaly indication is set; otherwise, a rate-based normal indication is output to S640. The rate-based normal indication is provided to S640 to allow for learning a baseline of the rate based and rate-invariant behavior. Both anomaly and normal indications are provided to S640.

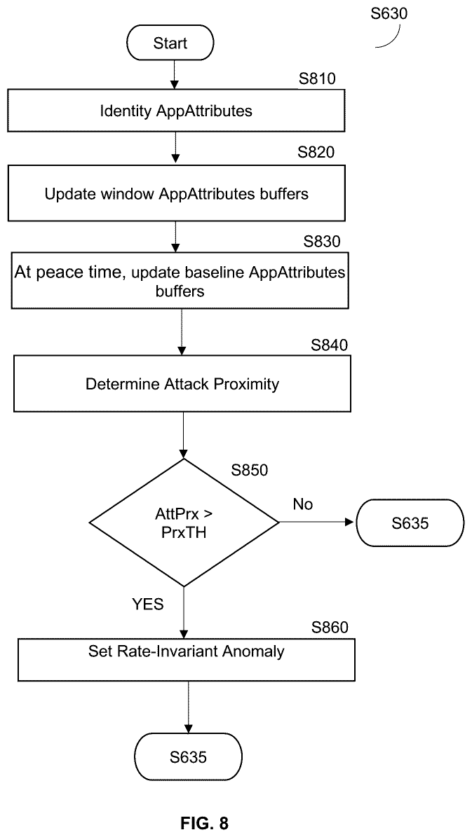

At S630, the received transactions are processed to determine if there is a rate-invariant anomaly in traffic directed to the victim server. In an embodiment, the rate-invariant anomaly is determined for a plurality of AppAttributes including, but not limited to, non-Standard HTTP headers (or unknown headers); cookies; query arguments in a URL; a HTTP request size, a HTTP response size; a challenge response, a HTTP response status code, User Agent values, client IP ego and other attributes, incoming traffic TLS fingerprinting, and the like. The execution of S630 is further discussed with reference to FIG. 8.

At S635, it is checked if a rate-invariant anomaly is determined, and if so, a rate-invariant anomaly indication is set; otherwise, a rate-invariant normal indication is output. Both anomaly and normal indications are provided to S640.

At S640, the rate-invariant and rate-based indications are processed to determine what type of an alert to output. Specifically, when the rate-invariant and rate-based anomaly indications are set, an alert on an attack is generated and output. Further, when the rate-based anomaly indication is set and rate-invariant normal indication is output, an alert of flash crowd traffic is output. In all other combinations, no other alerts are set.

In an embodiment, when an attack alert is generated, a mitigation action can be taken. A mitigation action may include blocking requests, responding with a blocking page response, reporting, and passing the request to the protected entity, and so on. In an embodiment, a mitigation resource may be provided with the characteristics of the attacker as represented by the dynamic applicative signature. That is, the general structure of HTTP requests generated by the attacker is provided to the mitigation resource. This would allow for defining and enforcing new mitigation policies and actions against the attacker. Examples of mitigation actions are provided above.

In an embodiment, the mitigation action includes blocking an attack tool at the source when the tool is being repetitively characterized as matched to the dynamic applicative signature. For example, if a client identified by its IP address or X-Forwarded—For HTTP header issues a high rate of HTTP requests that match the dynamic applicative signature, this client can be treated as an attacker (or as an attack tool). After a client is identified as an attacker, all future HTTP requests received from the identified attacker are blocked without the need to perform any matching operation to the signature.

At S650, the time window is reset, and execution returns to S610 where transactions received during a new time window are processed.

In an embodiment, when an attack is detected, the method may also determine an end-of-attack condition. Such a condition is detected when a preconfigured number of consecutive time windows rate-invariant or rate-based normal indications are output. The normal conditions are met when window_RPS or attack proximity are going below the normal baseline thresholds, RPS anomaly threshold or proximity threshold, multiply by some pre-defined factor (e.g., 0.8) to avoid oscillations.

When the end of the attack is detected, a grace period of a few time windows is dictated in order to enable safe transition back to peace time.

FIG. 7 shows an example flowchart S620 describing a method for detecting a rate-based anomaly according to an embodiment. The method will be discussed with reference to a specific example where a rate-based anomaly is determined respective to a packet per second (RPS) parameter.

At S710, the RPS of transactions received during the current window is computed as the number of received transactions (e.g., HTTP request) divided by the duration of the time window in seconds.

At S720, a short RPS baseline and a mid RPS baseline are determined. These baselines are the means and variance of the RPS as measured for previous time windows while applying different values of alpha filters and when there is no active attack. The short RPS baseline and a mid RPS baseline are discussed in more detail above. It should be emphasized that S720 is performed only during peace time when no attack is detected.

At S730, an RPS anomaly threshold is set based on the RPS baselines. In an embodiment, such a threshold is set a maximum value between the short and mid RPS thresholds calculated based on the short and mid RPS baselines.

At S740, the RPS for the current time window (WinRPS[n+1]) as determined at S710 is compared to the RPS anomaly threshold (RPS_TH). If the RPS exceeds the threshold, a rate-based anomaly is determined (S750). Then, execution returns to S625 (FIG. 6).

FIG. 8 shows an example flowchart S630 describing a method for detecting a rate-invariant anomaly according to an embodiment. The rate-invariant anomaly is determined based on AppAttributes.

At S810, transactions received during the current window are processed to at least identify AppAttributes in such transactions. The AppAttributes of various types, and for each AppAttributes type, at least a key is extracted or parsed out of the request.

At S820, window buffers for a current window are updated based on identified AppAttributes in the received transactions. This includes, for every previous AppAttributes key value, an occ field value, and weight field values that are incremented in the respective buffer. For the first occurrence of the AppAttributes key value, a new buffer is initiated, and the value is recorded therein. The new buffer for saving new occurrence values is dedicated. In both options, the weight and age fields are updated as mentioned above.

At S830, baseline buffers are updated based on window buffers. The update of the baseline buffers occurs only at peacetime, i.e., when an RPS normal indication is output. The update of the baseline is based on a simple addition or based on exponential averaging (e.g., by Alpha filter). The update of the baseline for newly seen AppAttributes occurs only when no anomaly is detected. The updated baseline buffers are discussed above.

At S840, an attack proximity is determined. The attack proximity indicates how statistically close the window buffers (for a current time window) are to baseline buffers. The attack proximity determination is discussed above.

At S850, the attack proximity is compared to the proximity threshold. If the attack proximity exceeds the proximity threshold, a rate-invariant anomaly is determined (S860). Either way, execution returns to S635 (FIG. 6).

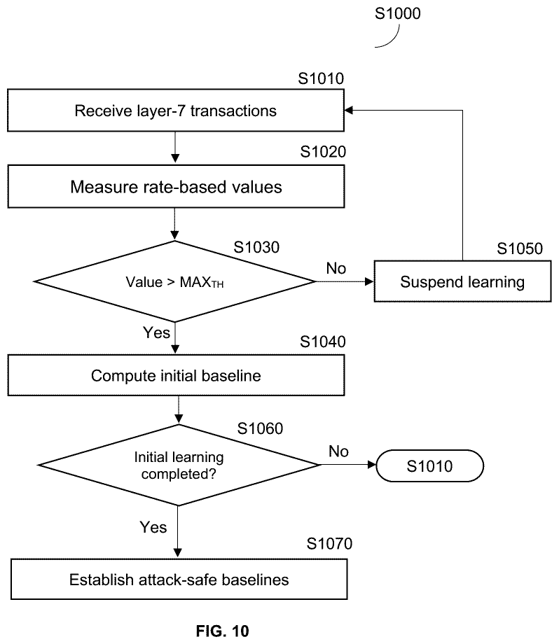

FIG. 10 shows a flowchart of an example process (1000) used for an initial learning process to establish an initial baseline in accordance with an embodiment. This baseline is established for a rate-based application attribute. The process shown in FIG. 10 can be carried out by the detection system (FIG. 1, 110) throughout the initial learning period and prior to the detection of DDOS attacks.

At S1010, application-layer transactions directed to a protected entity are received. For example, detection system 110 may receive application-layer transactions directed to a protected entity, as described above. The received transactions are web transactions and typically include HTTP requests and their corresponding responses to/from a protected entity hosted by a victim server. In an embodiment, S1010 may include receiving data during predefined time windows. The process is performed for each time window.

At S1020, values of at least one rate-based attribute are measured from the received application-layer transactions. For example, a rate-based attribute may include the incoming transactions requests per second (RPS) rate. In yet another embodiment, the rate-invariant attributes can also be measured during this stage.

At S1030, it is determined, based on the measured rate-based attribute, that the received application-layer transactions represent an initial normal behavior. Specifically, S1030 includes comparing the measured rate-based attribute to a predefined threshold related to a maximum rate-based attribute value. For example, if the measured rate-based attribute is RPS, the threshold is a maximum RPS (RPSMAX) so that RPS below this rate are considered as normal. In an embodiment, such a threshold is pre-configured. In another embodiment, the maximum threshold may be learned based on, for example, similar protected entities.

If S1030 results in a Yes answer (i.e., the value is below the maximum threshold), execution continues with S1040. Otherwise, if an abnormal rate-based attribute is detected, as S1050, the learning is suspended.

When an abnormal rate-based attribute is detected, the learning process comes to a halt. The suspension period lasts as long as the measured rate-based attribute is higher than the maximum threshold (MaxTH). The execution returns to S1010 where transactions received during a subsequent time window are processed, in part, to check if the rate-based value returns to a value below the maximum threshold, and if so, the suspension is ended. In an embodiment, the suspension period can be timed out (for example, after one hour). Once the suspension period is over, the learning process starts again, and the execution returns to S1010.

At S1040, an initial baseline is computed over the application-layer transactions determined to obtain an initial assessment of the actual rate-based normal behavior. The initial baseline is computed for rate-based attributes. In yet another embodiment, rate-invariant attributes (e.g., application attribute) initial baseline can also be calculated.

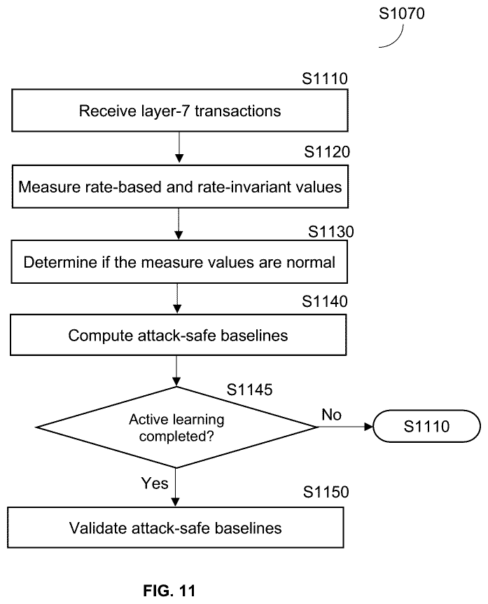

At S1060, it is determined if the initial learning phase has elapsed. If so, execution continues with S1070, where attack-safe baselines are actually established as discussed in FIG. 11. Otherwise, execution returns to S1010 where transactions received during a subsequent time window are processed.

In an embodiment, S1010 may include receiving data during predefined time windows. The process is performed for each time window. The time window is set to a predefined number of seconds.

In an embodiment, the duration of an initial learning period is pre-determined, e.g., 1 hour. In another embodiment, the initial learning period is based on a predefined number of processed transactions (for example, 5,000 transactions). It should be noted that the initial learning period may be a combination of the number of transactions and time duration.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a flowchart of an example process S1070 for safeguarding a learning process to establish attack-safe baselines during the active learning period according to an embodiment. The baselines may be for a rate-based and/or rate-invariant application attributes. The disclosed process of FIG. 11 may be performed by detection system 110 prior to the detection of DDOS attacks.

At S1110, application-layer transactions directed to a protected entity are received and analyzed. For example, detection system 110 may receive application-layer transactions directed to a protected entity, as described above. In an embodiment, the received transactions are web transactions and typically include HTTP requests and their corresponding responses to/from a protected entity hosted by a victim server. In an embodiment, S1110 may include receiving data during predefined time windows. The process is performed for each time window. The time window is set to a predefined number of seconds.

At S1120, values of at least one rate-based attribute and at least one rate-invariant attribute are measured from the received application-layer transactions. For example, a rate-based attribute may include requests per second. Other examples of rate-based and rate-invariant attributes from the received application-layer transactions are described above. In an embodiment, rate-invariant attributes are the various application attributes.

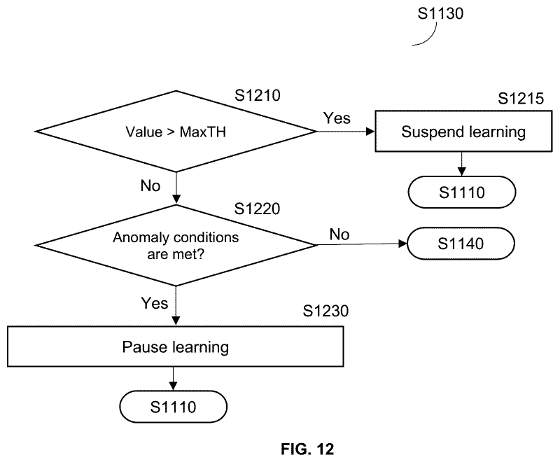

At S1130, it is determined, based on the measured rate-based attribute, that the received application-layer transactions represent normal behavior. In an embodiment, the determination is based on at least one measured rate-based attribute. Specifically, as will be discussed in detail below, the determination includes comparing the measured rate-based attribute to predefined thresholds related to the maximum and minimum values of the rate-based attribute. This further includes comparing the value of the rate-based attribute to an anomaly factor to determine any abnormal changes in the value. The learning process is paused when the measured rate-based attribute is determined to be abnormal. The time when the measured rate-based attribute is determined to be normal is referred to as an active learning time. The operation of S1130 is discussed in detail below. In another embodiment, the determination is based on at least one measured rate-invariant attribute. The operation of S1130 is discussed in more detail with reference to FIG. 12.

At S1140, baselines are computed over the application-layer transactions determined to represent the normal behavior. A baseline is computed for rate-based features and may include short and medium baselines. A baseline can also be computed for rate-invariant features, such as application attribute baselines, as discussed above.

At S1145, the process checks if the active learning period has ended. When the learning period has ended, the process moves to S1150. If not, the process returns to S1110 where new transactions received during the next time window are processed. The check performed at S1145 verifies if the active learning period was continuous. This means that the paused times during learning are not included in the active learning period. The duration of the learning period can be pre-configured to, for example, 24 hours or a specific number of processed transactions (such as 100,000). The learning period can be a combination of both time duration and number of transactions.

At S1150, after the active learning period has concluded, the computed baseline is validated. In an embodiment, the validation is performed on the measured rate-invariant and rate-based attributes.

In an embodiment, S1150 includes checking if two conditions are satisfied: one rate-based condition and another rate-invariant condition. The rate-based condition ensures that an adequate number of transactions are processed for the purpose of learning and may include, for example:

RateCondition>SuccessValidationRate

The RateCondition is defined as a ratio between the measured number of windows with adequate number of transactions and a validation period duration.

For example, the required measured number of windows with adequate number of transactions may include the number of windows slots with at least 500 transactions, and the validation period may be 24 hours. In an embodiment, the SuccessValidationRate is a pre-configured static threshold (e.g., 0.75). In an example, RateCondition may be 18 windows with the pre-defined number of transactions received for 24 hours, thus the rate condition is 18/24=0.75. The active learning period may be the same as the validation period.

In an embodiment, the rate-invariant condition ensures a stable measurement of the application behavior attribute that is substantially below the application behavior threshold, throughout the active learning period. The rate-invariant condition is measured by the AverageAppBehaviorMargin attribute and is calculated as:

AverageAppBehaviorMargin>SuccessValidationAppMargin

The SuccessValidationAppMargin is a static threshold (e.g., 0.5). The AverageAppBehaviorMargin is a measured metric that represents the distance between the rate-invariant attribute and its threshold. The SuccessValidationAppMargin is calculated as follows:

$$AverageAppBehaviorMargin = \frac{1}{N} \cdot {\sum }_{i = 0}^{N - 1} \frac{AppBehaviorTH [ n - i ] - AppBehavior [ n - i ]}{AppBehaviorTH [ n - i ]}$$

where, N represents the number of time windows of active learning.

It should be noted that for successful learning to be achieved, both rate-based and rate-invariant conditions should be met. If the successful learning conditions are not met, the entire learning is re-initiated for several attempts (e.g., 3 attempts). After a successful learning period, the behavioral detection of attacks can be safely initiated. In an embodiment, if the learning was not successful, the detection may be based on rate-based attributes only.

In an embodiment, the rate-based attributes only detect a HTTP Floods attack based on the rate attributes only (and doesn't use rate-invariant attributes as they can't be calculated accurately). The rate-based only attack detection threshold is calculated the same way as was described above for rate-based anomaly detection.

In another embodiment, after the learning was concluded and rate-based attributes only detection is operated, the baseline validation is continued as a background process. The validation conditions are checked at each pre-defined period of time, for example, each 24 hours. If, during the validation, the two conditions are met, the detection is turned to be based on full behavioral attributes, rate-based and rate-invariant features as specified above.

Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a flowchart of an example process S1130 for determining if application-layer transactions represent a normal behavior according to the disclosed embodiments.

At S1210, the value of the measured rate-based attribute is compared to a threshold (MaxTH) representing a maximum learnable value for the rate-based attribute, meaning that the values above are considered high-rate anomalies, and thus should not be learned during the learning period. In an embodiment, high-rate anomalies can be a potential for HTTP flood attacks that should not be learned. If S1210 results in a Yes answer, the learning is suspended (S1215). Otherwise, execution continues with S1220. As noted above, after the suspension time, the learning process is restarted. Alternatively, the learning is resumed when the rate-based attribute returns to values below the MaxTH.

Thus, according to this embodiment, the value of the measured rate-based attribute below the high threshold potentially represents normal behavior and introduces active learning. It should be noted that the MaxTH.threshold is applicable during the initial learning.

At S1220, it is determined if a value of the measured rate-based attribute has changed by an anomaly factor, during a time window. In an embodiment, a measured rate-based attribute that has not changed by the anomaly factor represents a normal behavior that can be considered as attack-safe conditions and therefore the baselines can be learned. In an embodiment, S1220 includes checking if one of two conditions is met: “learning anomaly high” and “learning anomaly low” are met. These conditions may be defined as follows.
1. Learning Anomaly High

RateAttribute>rateShortAverage*LearnAnomalyFactor

and

RateAttribute>MinTH
2. Learning Anomaly Low

RateAttribute<rateShortAverage/LearnAnomalyFactor

and

rateShortAverage>MinRps

The rateShortAverage is a calculated average over a short period of time (e.g., 1 hour). In one embodiment, the LearnAnomalyFactor is a static configurable number (e.g., set to 5 by default). In another embodiment, the LearnAnomalyFactor is a behavioral calculated factor. The RateAttribute is a value of the measured rate-based attribute. In an embodiment, the RateAttribute is the average RPS measured on a time window. The MinTH is a threshold representing a minimum value for the rate-based attribute. Such a threshold may be predetermined and, for example, represents RPS values that should never be considered as an attack. Note that when rate-based value (e.g., RPS) is lower than the MinTH, the incoming traffic is learned.

If S1220 results with a Yes (e.g., one of the Learning Anomaly High and Learning Anomaly Low conditions is met), execution proceeds for S1230; otherwise, execution continues with S1140 (FIG. 11) where the baselines are established based on normal values.

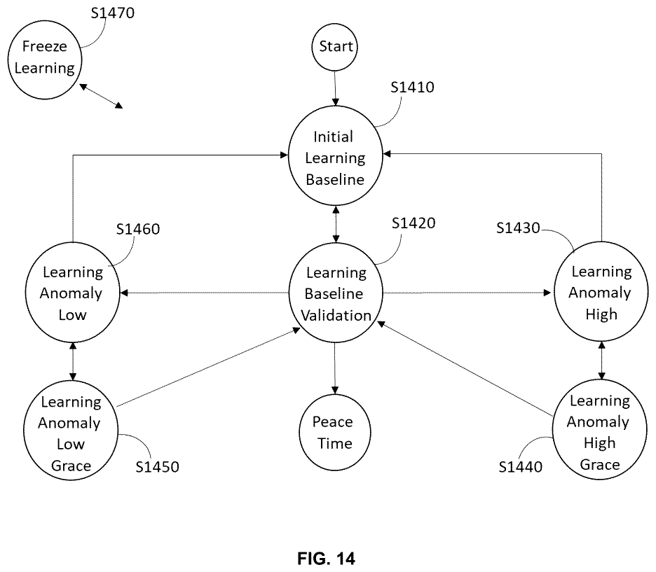

At S1230, the learning is paused. It should be noted that the learning is paused as long as the measured rate-based attribute anomaly behavior remains persistent. While pausing the learning, values of new transactions are checked against the above-mentioned anomaly conditions (for example, such as in S1210, S1220). According to an embodiment, a state machine is implemented to resume learning. The state machine comes to ensure that traffic has returned to normal values before the resumption of learning the baseline. An example state machine is provided in FIG. 14.

The process described with reference to FIG. 12 is performed as long as new transactions are received during the active learning period.

Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

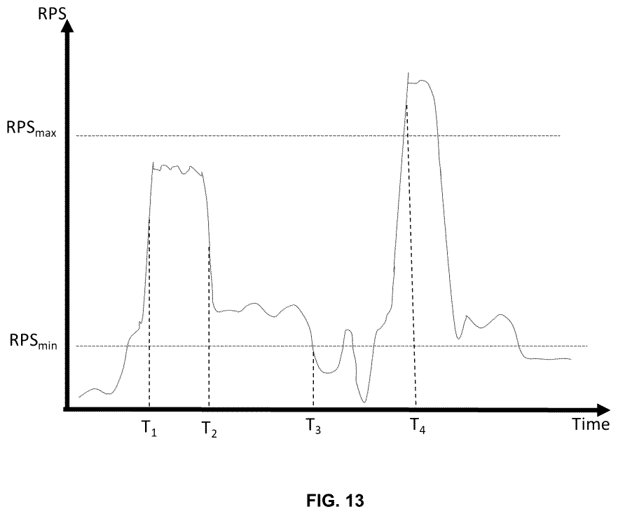

FIG. 13 shows an example graph 1300 demonstrating the process described in FIGS. 10, 11 and 12. The rate-based attribute measured in FIG. 13 is incoming requests per second (RPS). The maximum and minimum thresholds are marked as MaxRPS and MinRPS. At time T1, the learning is paused due to a steep increase in RPS; at time T2, Learning is paused due to a steep decrease in RPS; at time T3, the base learning is paused as the RPS is lower than RPSmin; and at time T4 the baseline learning is paused as the RPS is higher than RPSmax.

FIG. 14 shows an example diagram of a state machine illustrating the process performed during the baseline learning period according to an embodiment.

The learning process is divided into two states. The first state, documented as S1410, is the initial learning process, which is illustrated in FIG. 10. When the initial learning process is completed successfully, the next state S1420 focuses on the active learning and validating the baselines for rate-based and rate-invariant features. The objective of S1420 is to ensure the required duration of actual active learning without any potential anomalies. In an embodiment, the active learning duration can be at least 24 hours. At the end of this time, the detection system checks the “quality of learning” by verifying that the “successful learning conditions” have been met. If the successful learning conditions are not met, the entire learning process is re-initiated a pre-configured number of times (e.g., 3 times). Once the successful learning conditions are met, peacetime anomaly detection and mitigation can be started based on baselines. If the learning process is successful, accurate attack detection can begin.

Execution continues with S1470, S1430, or S1440 depending on which of the anomaly conditions has been met. For example:
1. when the condition RPS>MaxTH is met; move to state S1470;
2. when the learning high anomaly condition is met; move to S1430; and
3. when the learning low anomaly condition is met; move to state S1460.

S1430 is the state of high learning anomaly. In this state, the system checks if the high-rate condition has ceased. If so, it moves to S1440, which corresponds to the learning anomaly high grace state. However, if the high-rate condition persists for a period longer than a pre-determined period of time, e.g., 5 hours, the system returns to S1410 to re-initiate the baseline learning.

S1440 is the learning anomaly high grace state. Here, it is checked if the learning high anomaly condition has not been resumed, for example, for the last 2 minutes. If so, the system returns to S1420; otherwise, the system returns to S1430. It should be noted that the state machine operates similarly at S1450 and S1460. The check at both states is against the low anomaly condition.

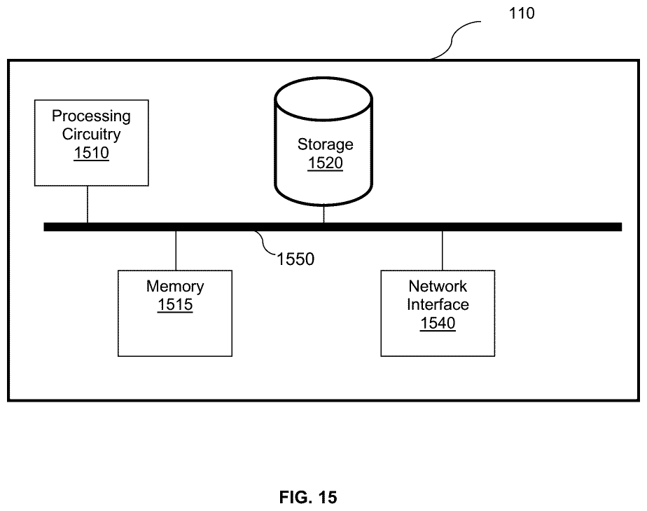

FIG. 15 is an example block diagram of the system 110 implemented according to an embodiment. The detection system 110 includes a processing circuitry 1510 coupled to a memory 1515, a storage 1520, and a network interface 1540. In another embodiment, the components of system 110 may be communicatively connected via bus 1550.

The processing circuitry 1510 may be realized as one or more hardware logic components and circuits. For example, and without limitation, illustrative types of hardware logic components that can be used include field-programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 1515 may be volatile (e.g., RAM, etc.), non-volatile (e.g., ROM, flash memory, etc.), or a combination thereof. In one configuration, computer-readable instructions to implement one or more embodiments disclosed herein may be stored in storage 1520.

In another embodiment, the memory 1515 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by one or more processors, cause the processing circuitry 1510 to perform the various processes described herein. Specifically, the instructions, when executed, cause the processing circuitry 1510 to perform the embodiments described herein. The memory 1515 can be further configured to store the buffers.

The storage 1520 may be magnetic storage, optical storage, and the like, and may be realized, for example, as flash memory or other memory technology, CD-ROM, Digital Versatile Disks (DVDs), or any other medium that can be used to store the desired information.

The processing circuitry 1510 is configured to detect and cause detection of HTTPS flood attacks as described herein.

The network interface 1540 allows the device to communicate at least with the servers and clients. It should be understood that the embodiments described herein are not limited to the specific architecture illustrated in FIG. 15, and other architectures may be equally used without departing from the scope of the disclosed embodiments. Further, the system 110 can be structured using the arrangement shown in FIG. 15

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

What is claimed is:

1. A method for learning attack-safe baseline, comprising:
receiving application-layer transactions directed to a protected entity;
measuring values of a rate-based attribute and a rate-invariant attribute from the received application-layer transactions;
determining, based on the measured rate-based attribute, if the received application-layer transactions represent a normal behavior;
computing at least one baseline using application-layer transactions determined to represent the normal behavior; and
validating the at least one computed baseline using the measured rate-invariant attribute and rate-based attribute.

2. The method of claim 1, wherein determining if the received application-layer transactions represent a normal behavior, further comprises:
providing an initial assessment of the measured rate-based attribute.

3. The method of claim 2, wherein determining if the received application-layer transactions represent a normal behavior, further comprises:
comparing the measured rate-based attribute to a first threshold and a second threshold, wherein the first threshold represents a maximum value for the rate-based attribute and the second threshold represents a minimum value for the rate-based attribute, wherein a measured rate-based attribute above the first threshold represents an abnormal behavior.

4. The method of claim 2, further comprising:
determining if the measured rate-based attribute has changed by an anomaly factor, wherein a measured rate-based attribute that has not changed by the anomaly factor represents a normal behavior.

5. The method of claim 4, wherein determining if the measured rate-based attribute has changed by an anomaly factor, further comprises:
checking if a current measured value of the rate-based attribute changes from its respective average value by the anomaly factor.

6. The method of claim 4, further comprising:
pausing the baseline learning when a received measured rate-based represents an abnormal behavior.

7. The method of claim 4, further comprising:
re-initiating the baseline learning when a received measured rate-based represents a normal behavior.

8. The method of claim 1, wherein validating the computed rate-based baseline further comprises:
determining if a preconfigured active learning period has been completed, wherein the preconfigured active learning period includes durations or a number of transactions received during which application-layer transactions determined to represent the normal behavior utilized to compute the at least one baseline; and
determining if a quality learning condition has been met.

9. The method of claim 8, wherein the determining if a quality learning condition includes checking if a measured rate-invariant attribute is higher than a rate-invariant quality threshold and a measured rate-based attribute is higher than a rate-based quality threshold.

10. The method of claim 9, further comprising:
determining that the baseline cannot be established for the protected entity when the at least one computed baseline learned has not met at least one quality learning condition.

11. The method of claim 1, wherein the at least one computed baseline determines a normal behavior of an application attribute (AppAttribute) of the protected entity during peacetime.

12. The method of claim 1, further comprising:
establishing short and medium baselines for at least one rate-based attributed using the at least one computed baseline.

13. The method of claim 1, wherein the at least one computed baseline determines a normal behavior of a traffic parameter of the protected entity during peacetime, wherein the traffic parameter may be any one of: a rate-based attribute and a rate-invariant attribute.

14. The method of claim 1, wherein further comprising:
computing the at least one baseline during time windows.

15. The method of claim 1, wherein application-layer transactions include any one of:
HTTP requests, HTTP responses, HTTPs requests, and HTTPs responses.

16. The method of claim 15, wherein application-layer transactions include samples of the actual HTTP requests, their corresponding HTTP responses, wherein a sampling rate of the actual HTTP requests differs as a function of the protected entity incoming traffic volumes.

17. The method of claim 1, wherein the attack-safe baselines are utilized for detecting application-layer flood denial-of-service (DDOS) attacks carried by attackers utilizing advanced application layer flood attack tools.

18. A system for learning attack-safe baseline comprising:
one or more processors configured to:
receive application-layer transactions directed to a protected entity;
measure values of a rate-based attribute and a rate-invariant attribute from the received application-layer transactions;
determine, based on the measured rate-based attribute, if the received application-layer transactions represent a normal behavior;
compute at least one baseline using application-layer transactions determined to represent the normal behavior; and
validate the at least one computed baseline using the measured rate-invariant attribute and rate-based attribute.

19. The system of claim 18, wherein the one or more processors, when determining if the received application-layer transactions represent a normal behavior, are configured to:
provide an initial assessment of the measured rate-based attribute.

20. The system of claim 19, wherein the one or more processors, when determining if the received application-layer transactions represent a normal behavior, are configured to:
compare the measured rate-based attribute to a first threshold and a second threshold, wherein the first threshold represents a maximum value for the rate-based attribute and the second threshold represents a minimum value for the rate-based attribute, wherein a measured rate-based attribute above the first threshold represents an abnormal behavior.

21. The system of claim 19, wherein the one or more processors are further configured to:
determine if the measured rate-based attribute has changed by an anomaly factor, wherein a measured rate-based attribute that has not changed by the anomaly factor represents a normal behavior.

22. The system of claim 21, wherein the one or more processors, when determining if the measured rate-based attribute has changed by an anomaly factor, are configured to:
check if a current measured value of the rate-based attribute changes from its respective average value by the anomaly factor.

23. The system of claim 21, wherein the one or more processors are further configured to:
pause the baseline learning when a received measured rate-based represents an abnormal behavior.

24. The system of claim 21, wherein the one or more processors are further configured to:
re-initiate the baseline learning when a received measured rate-based represents a normal behavior.

25. The system of claim 18, wherein the one or more processors, when validating the computed rate-based baseline, are configured to:
determine if a preconfigured active learning period has been completed, wherein the preconfigured active learning period includes durations or a number of transactions received during which application-layer transactions determined to represent the normal behavior utilized to compute the at least one baseline; and
determine if a quality learning condition has been met.

26. The system of claim 25, wherein the determining if a quality learning condition includes checking if a measured rate-invariant attribute is higher than a rate-invariant quality threshold and a measured rate-based attribute is higher than a rate-based quality threshold.

27. The system of claim 26, wherein the one or more processors are further configured to:
determine that the baseline cannot be established for the protected entity when the at least one computed baseline learned has not met at least one quality learning condition.

28. The system of claim 18, wherein the at least one computed baseline determines a normal behavior of an application attribute (AppAttribute) of the protected entity during peacetime.

29. The system of claim 18, wherein the one or more processors are further configured to:
establish short and medium baselines for at least one rate-based attributed using the at least one computed baseline.

30. The system of claim 18, wherein the at least one computed baseline determines a normal behavior of a traffic parameter of the protected entity during peacetime, the traffic parameter may be any one of:
a rate-based attribute and a rate-invariant attribute.

31. The system of claim 18, wherein further comprising:
computing the at least one baseline during time windows.

32. The system of claim 18, wherein application-layer transactions include any one of:
HTTP requests, HTTP responses, HTTPs requests, and HTTPs responses.

33. The system of claim 32, wherein application-layer transactions include samples of the actual HTTP requests, their corresponding HTTP responses, a sampling rate of the actual HTTP requests differs as a function of the protected entity incoming traffic volumes.

34. The system of claim 18, wherein the attack-safe baselines are utilized for detecting application-layer flood denial-of-service (DDOS) attacks carried by attackers utilizing advanced application layer flood attack tools.

35. A non-transitory computer-readable medium storing a set of instructions for learning attack-safe baseline, the set of instructions comprising:
one or more instructions that, when executed by one or more processors of a device, cause the device to:
receive application-layer transactions directed to a protected entity;
measure values of a rate-based attribute and a rate-invariant attribute from the received application-layer transactions;
determine, based on the measured rate-based attribute, if the received application-layer transactions represent a normal behavior;
compute at least one baseline using application-layer transactions determined to represent the normal behavior; and
validate the at least one computed baseline using the measured rate-invariant attribute and rate-based attribute.
